(19) United States
(12) Patent Application Publication
(10) Pub. No.: US 2024/0050307 A1
(43) Pub. Date: Feb. 15, 2024

(54) Drive Mechanism and Massage Device

(71) Applicant: Dongguan Renchun Electronics Co., Ltd., Dongguan (CN)

(72) Inventor: Chenggui Luo, Dongguan (CN)

(21) Appl. No.: 17/945,114

(22) Filed: Sep. 15, 2022

(30) Foreign Application Priority Data
Aug. 9, 2022 (CN) 202222094527.8

(51) Int. Cl. A61H 19/00

(52) U.S. Cl. CPC A61H 19/44; A61H 2201/1215; A61H 2201/1669; A61H 2201/149

(57) ABSTRACT

The present disclosure provides a drive mechanism and a massage device, and relates to the technical field of daily necessities. The drive mechanism includes a drive member, an active component and a support member; the active component is sleeved on the support member, and an inner wall of the active component resists to an outer wall of the support member; the drive member is in transmission connection with the active component, so as to drive the active component to make a straight reciprocating movement along an axis direction of the support member; and an outer diameter of the active component is increased or reduced along the movement of the active component. The technical problem that the massage device cannot achieve the simulated effect is solved in the present disclosure.

### CROSS REFERENCE TO RELATED APPLICATIONS

The present application claims the benefit of Chinese Patent Application No. 202222094527.8 filed on Aug. 9, 2022, the contents of which are incorporated herein by reference in their entirety.

### TECHNICAL FIELD

The present disclosure relates to the technical field of sex toys, in particular to a drive mechanism and a massage device.

### BACKGROUND

Sexual need is the basic need of human life. In aspect of the sexual need, since the society is free and open, adult men and women sometimes use sex toys to enhance sexual interest, thereby achieving the function of relieving the life stress. However, a common massage device supported by a male reproductive organ is usually composed of a rod extending integrally, or an electric motor is added so that the rod can generate the massage effect, but the simulated effect cannot be achieved, so users will lose interest after using the massage device for a period of time.

### SUMMARY

The purpose of the present disclosure is to provide a drive mechanism and a massage device, so as to alleviate the technical problem that massage supplies cannot achieve the simulated effect in the prior art.

In order to solve the above problem, the present disclosure provides the technical solution below:

a drive mechanism provided by the present disclosure includes a drive member, an active component and a support member;

the active component is sleeved on the support member, and an inner wall of the active component resists to an outer wall of the support member;

the drive member is in transmission connection with the active component, so as to drive the active component to make a straight reciprocating movement along an axis direction of the support member; and

an outer diameter of the active component is increased or reduced along the movement of the active component.

Further,

the active component includes an installation part and a plurality of frameworks;

the installation part is connected to the drive member;

one end of each framework is connected to the installation part, and an inner wall of each framework resists to the support member; and

the plurality of frameworks are arranged along a circumferential direction of the installation part at intervals, so as to form a containing space for containing the support member, and an inner diameter of the containing space is gradually reduced from one end away from the installation part to one end closing to the installation part.

Further,

each framework includes a main framework and an auxiliary framework;

one side of the auxiliary framework fits with an inner wall of the main framework, and the other side of the auxiliary framework is set as a first inclined plane; and

the first inclined plane inclines in an axis direction closing to the installation part from one end away from the installation part to one end closing to the installation part.

Further,

the drive mechanism further includes a transmission component;

the transmission component includes a screw and a nut seat;

the screw is fixedly connected to an output shaft of the drive member; and

the nut seat is sleeved on the screw, and connected to the active component or the support member.

Further,

when the nut seat is connected to the active component, the nut seat is detachably connected to the installation part through a clamping structure;

the clamping structure includes installation blocks or grooves that are arranged on the nut seat, and the grooves or the installation blocks that are correspondingly arranged on the installation part; and

the installation blocks are inserted into the grooves, and fasteners are in threaded connection with the grooves by penetrating through the installation blocks.

Further,

the drive mechanism further includes a shell;

one end of the shell is inserted into the active component, and connected to the support member; and

the drive member and the transmission component are arranged in the shell.

Further, the shell is provided with guide grooves;

the guide grooves penetrate through the shell along a thickness direction of the shell, and length directions of the guide grooves are arranged along an axis direction of the drive member; and

the installation blocks penetrate through the guide grooves, and the guide grooves are configured to guide a movement direction of the nut seat.

Further,

the support member is provided with a plurality of installation grooves; and

the plurality of installation grooves are in sliding fit with the plurality of auxiliary frameworks correspondingly.

Further,

when the nut seat is connected to the support member, the drive mechanism further includes a fixed member; and

one end of the support member is sleeved with the nut seat while the other end is connected to the fixed member by penetrating through an end face away from the installation part of the active component, thereby achieving the transmission connection between the active component and the drive member.

According to a second aspect, the massage device provided by the present disclosure includes the drive mechanism described above.

Based on the above technical solution, the technical effect achieved by the present disclosure is analyzed as follows:

the drive mechanism provided by the present disclosure includes the drive member, the active component and the support member; the active component is sleeved on the support member, and the inner wall of the active component resists to the outer wall of the support member; the drive member is in transmission connection with the active component, so as to drive the active component to make the straight reciprocating movement along the axis direction of the support member; and the outer diameter of the active component is increased or reduced along the movement of the active component. The inner wall of the active component is connected to the outer wall of the support member, the support member can provide support force to the inner wall of the active component, so as to support the active component; the drive member is in transmission connection with the active component, so as to achieve the straight reciprocating movement along the axis of a drive shaft of the drive member, thereby achieving the stretching function of the massage device; and when the active component moves back and forth, the outer diameter of the active component is changed, thereby achieving the expanding and reducing effects of the massage device, and improving the simulated effect of the massage device.

### BRIEF DESCRIPTION OF THE DRAWINGS

To better clarify the specific implementation modes of the present disclosure or the technical solution in the prior art, the drawings required to illustrate the specific implementation modes or the prior art will be simply described below. It is apparent that the drawings described below merely illustrate some embodiments of the present disclosure. Those ordinarily skilled in the art can obtain other drawings without creative labor on the basis of those drawings.

FIG. 1 is a sectional drawing of a drive transmission provided by embodiment I of the present disclosure.

FIG. 2 is a sectional drawing of a massage device provided by embodiment I of the present disclosure.

FIG. 3 is a solid schematic diagram of an active component in a drive transmission provided by embodiment I of the present disclosure.

FIG. 4 is a solid schematic diagram of a transmission component in a drive transmission provided by embodiment I of the present disclosure.

FIG. 5 is a solid schematic diagram of a support member in a drive transmission provided by embodiment I of the present disclosure.

FIG. 6 is a solid schematic diagram of a shell in a drive transmission provided by embodiment I of the present disclosure.

FIG. 7 is a solid schematic diagram of a massage device provided by embodiment I of the present disclosure.

FIG. 8 is a sectional drawing of a drive transmission provided by embodiment II of the present disclosure.

FIG. 9 is a solid schematic diagram of a drive transmission provided by embodiment II of the present disclosure.

FIG. 10 is a solid schematic diagram of an active component in a drive transmission provided by embodiment II of the present disclosure.

FIG. 11 is a solid schematic diagram of a support member in a drive transmission provided by embodiment II of the present disclosure.

FIG. 12 is a solid schematic diagram of a fixed member in a drive transmission provided by embodiment II of the present disclosure.

FIG. 13 is a splitting schematic diagram of a drive member in a drive transmission provided by embodiment II of the present disclosure.

### REFERENCE SIGNS

100—Drive member, 200—Active component, 210—Framework, 211—Main framework, 212—Auxiliary framework, 213—Main body, 214—Installation section, 215—First inclined plane, 220—Containing space, 230—Groove, 240—Installation part, 300—Support member, 310—Installation groove, 311—Second inclined plane, 320—Slot, 330—Locating bulge, 400—Transmission component, 410—Screw, 420—Nut seat, 421—Installation block, 422—Through hole, 500—Shell, 510—Guide groove, 520—Bulge, 600—Fixed member, 610—Clamping hole, 220—Connecting end face, 221—Installation hole, 110—Main engine, 120—Outer shell, 121—Upper cover, 122—Lower cover.

### DETAILED DESCRIPTION OF THE EMBODIMENTS

In order to make the objectives, technical solution and advantages of the present disclosure clearer, the technical solutions in the embodiments of the present disclosure are clearly and completely elaborated below in combination with the drawings. It is apparent that the described embodiments are a part of the embodiments of the present disclosure but not all. Usually, the components of embodiments of the present disclosure described and shown in the drawing here may be arranged and designed in various different configurations.

Therefore, the detail description for the embodiments of the present disclosure provided in the drawings below is not intended to limit the protection scope of the present disclosure, and merely shows the selected embodiments of the present disclosure. Based on the embodiments of the present disclosure, all the other embodiments obtained by those of ordinary skill in the art on the premise of not contributing creative effort should belong to the protection scope of the present disclosure.

It is noted that the similar sign and letter show the similar items in the drawing below, therefore, once an item is defined in one drawing, it will not be further defined or explained in the attached drawings.

In the description of the present disclosure, it is noted that orientation or position relationships indicated by the terms “center”, “upper”, “lower”, “left”, “right”, “vertical”, “horizontal”, “inner”, “outer” and the like are based on the orientation or position relationships of the usual placement of the products of the present disclosure when being used, for ease of describing the present disclosure and simplifying the description only, rather than indicating or implying that the mentioned apparatus or element necessarily has a particular orientation and must be constructed and operated in the particular orientation. Therefore, these terms should not be understood as limitations to the present disclosure. In addition, the terms “first”, “second”, “third” and the like are merely used for distinguishing the description, instead of being understood as indicating or implying relative importance.

In addition, the terms “horizontal”, “vertical”, “suspension” and the like do not mean that the component is required to be absolutely horizontal or suspended, but can be slightly tilted. The term “horizontal” merely means that the direction is more horizontal than the term “vertical”, but does not mean that the structure must be completely horizontal, but can be slightly tilted.

In the description of the present disclosure, it is noted that, unless specific regulation and limitation otherwise, terms “set”, “install”, “join” and “connect” should be generally understood, for example, may a fixed connection, or a detachable connection, or an integrated connection, may a mechanical connection or an electric connection, may a direct connection or an indirect connection through an intermediation, and may an internal connection of two elements. Those of ordinary skill in the art may understand the specific meaning of the terms in the present disclosure according to specific conditions.

Some implementation modes of the present disclosure are described in details in combination with the drawings. Embodiments in the present disclosure and features in the embodiments may be combined with each other without conflict.

### Embodiment I

The existing massage device has the problem that the simulated effect cannot be achieved.

For this purpose, a drive mechanism provided by the present disclosure includes a drive member 100, an active component 200 and a support member 300; the active component 200 is sleeved on the support member 300, and an inner wall of the active component 200 resists to an outer wall of the support member 300; the drive member 100 is in transmission connection with the active component 200, so as to drive the active component 200 to make a straight reciprocating movement along an axis direction of the support member 300; and an outer diameter of the active component 200 is increased or reduced along the movement of the active component 200. The inner wall of the active component 200 is connected to the outer wall of the support member 300, the support member 300 can provide support force to the inner wall of the active component 200, so as to support the active component 200; the drive member 100 is in transmission connection with the active component 200, so as to achieve the straight reciprocating movement of the active component 200 along the axis of the drive member 100, thereby achieving the stretching function of the massage device; and when the active component 200 moves back and forth, the outer diameter of the active component 200 is changed, thereby achieving the expanding and reducing effects of the massage device, and improving the simulated effect of the massage device.

In an optional solution of the embodiment in the present disclosure, the active component 200 includes an installation part 240 and a plurality of frameworks 210; the installation part 240 is in transmission connection with the drive member 100; one end of each framework 210 is connected to the installation part 240, and an inner wall of each framework 210 resists to the support member 300; and the plurality of frameworks 210 are arranged along a circumferential direction of the installation part 240 at intervals, so as to form a containing space 220 for containing the support member 300, and an inner diameter of the containing space 220 is gradually reduced from one end away from the installation part 240 to one end closing to the installation part 240.

Specifically, a section of the installation part 240 is circular, and the frameworks 210 are fixedly connected to the installation part 240. Certainly, other connection types, such as plugging should be within the protection scope of the embodiments of the present disclosure. Further, the frameworks 210 are made of elastic materials, such as plastics, rubbers, etc.

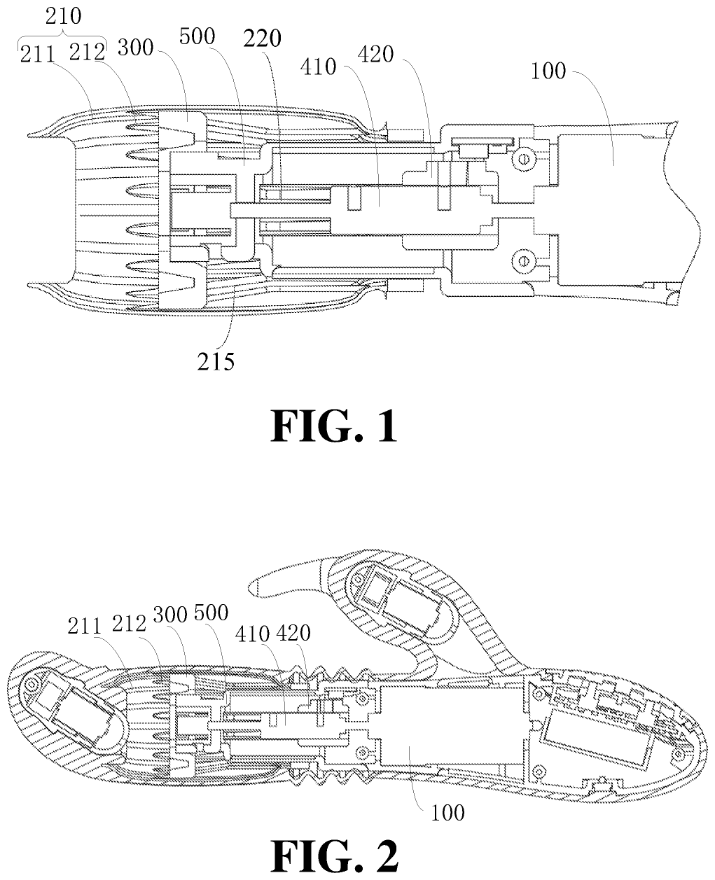

The inner diameter of the containing space 220 is gradually reduced from one end away from the installation part 240 to one end closing to the installation part 240. Taking FIG. 1 as an example, when the drive member 100 drives the installation part 240 to move left, the inner wall of each framework 210 keeps fitting with the outer wall of the support member 300; and the inner diameter of the containing space 220 is gradually increased from right to left, so the distance between the outer wall of the framework 210 and the outer wall of the support member 300 is getting greater and greater, so as to achieve the greater and greater outer diameter of the active component 200. When the drive member 100 drives the installation part 240 to move right, the inner wall of each framework 210 keeps fitting with the outer wall of the support member 300; and the inner diameter of the containing space 220 is gradually reduced from left to right, so the distance between the outer wall of the framework 210 and the outer wall of the support member 300 is getting smaller and smaller, so as to achieve the smaller and smaller outer diameter of the active component 200.

In an optional solution of the embodiment of the present disclosure, each framework 210 includes a main framework 211 and an auxiliary framework 212; one side of the auxiliary framework 212 fits with an inner wall of the main framework 211, and the other side of the auxiliary framework 212 is set as a first inclined plane 215; and the first inclined plane 215 inclines in an axis direction closing to the installation part 240 from one end away from the installation part 240 to one end closing to the installation part 240.

Specifically, please refer to FIG. 1 and FIG. 2, the quantity of the framework 210 may be two, four or eight, etc. The main framework 211 and the auxiliary framework 212 are all strip, and the main framework 211 is mutually vertical to the auxiliary framework 212.

The side of the auxiliary framework 212 is set as the first inclined plane 215, and the first inclined plane 215 inclines in the axis direction closing to the installation part 240 from one end away from the installation part 240 to one end closing to the installation part 240, so that the inner diameter of the containing space 220 is gradually reduced from one end away from the installation part 240 to one end closing to the installation part 240, thereby achieving the increased or reduced outer diameter of the active component 200 under the drive of the drive member 100.

In an optional solution of the embodiment of the present disclosure, each framework 210 includes a main body 213 and two installation sections 214, and the two installation sections 214 are respectively located at the two ends of the main body 213; and the two installation sections 214 are in included angle setting with the main body 213, and located at the same side of the main body 213.

Specifically, the main body 213 is integrally formed with the two installation sections 214, and bending is carried out by using a material so as to form the framework 210 with the main body 213 and the two installation sections 214. The main body 213 is set as an arc sinking away from the axis direction of the installation part 240. Further, the included angle between the main body 213 and the installation sections 214 is an obtuse angle.

The two installation sections 214 are respectively located at the two ends of the main body 213, and the included angle between the two installation sections 214 and the main body 213 is set as the obtuse angle, so the distance between the main body 213 and the axis of the installation part 240 is greater than that between the installation sections 214 and the axis of the installation part 240. When installing the main framework 211, the two installation sections 214 match with other accessories, and one installation section 214 matches with the installation part 240, so as to achieve the installation of the active component 200.

In an optional solution of the embodiment of the present disclosure, the support member 300 is provided with a plurality of installation grooves 310; and the plurality of installation grooves 310 are in sliding fit with the plurality of auxiliary frameworks 212 correspondingly.

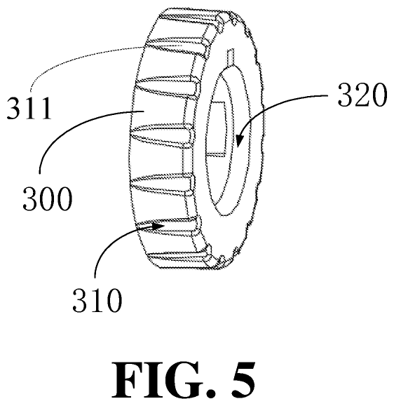

Specifically, please refer to FIG. 5, the installation grooves 310 sink from a peripheral surface of the support member 300 to the axis direction of the installation part 240, and the plurality of installation grooves 310 are arranged at intervals along the circumferential direction of the support member 300.

The installation grooves 310 are in sliding fit with the auxiliary framework 212, and the installation grooves 310 play a role in guiding the frameworks 210.

In an optional solution of the embodiment of the present disclosure, a bottom wall of each installation groove 310 is set as a second inclined plane 311, and the second inclined plane 311 inclines in an axis direction closing to the installation part 240 from one end away from the installation part 240 to one end closing to the installation part 240.

Specifically, taking FIG. 1 as an example, when the drive member 100 drives the installation part 240 to move left, the inner wall of the auxiliary framework 212 fits with the bottom walls of the installation grooves 310; and the second inclined plane 311 inclines in the axis direction away from the installation part 240 from right to left, so the distance between the bottom walls of the installation grooves 310 and the axis of the installation part 240 is increased, and then the distance between the outer wall of the main framework 211 and the axis of the installation part 240 is increased, so as to achieve greater and greater outer diameter of the active component 200. When the drive member 100 drives the installation part 240 to move right, the inner wall of the auxiliary framework 212 fits with the bottom walls of the installation grooves 310; and the second inclined plane 311 inclines in the axis direction closing to the installation part 240 from left to right, so the distance between the bottom walls of the installation grooves 310 and the axis of the installation part 240 is reduced, and then the distance between the outer wall of the main framework 211 and the axis of the installation part 240 is reduced, so as to achieve the smaller and smaller outer diameter of the active component 200.

On the basis that the inner diameter of the containing space 220 is gradually reduced from one end away from the installation part 240 to one end closing to the installation part 240, a mode that the bottom wall of each installation groove 310 is set as the second inclined plane 311 is increased, and the second inclined plane 311 inclines in the axis direction closing to the installation part 240 from one end away from the installation part 240 to one end closing to the installation part 240, thereby increasing the change scope of the outer diameter of the active component 200. Certainly, the structure that the inner diameter of the above containing space 220 is gradually reduced from one end away from the installation part 240 to one end closing to the installation part 240 is only adopted, or the structure that the bottom wall of each installation groove 310 is set as the second inclined plane 311 and the second inclined plane 311 inclines in the axis direction closing to the installation part 240 from one end away from the installation part 240 to one end closing to the installation part 240 should be also within the protection scope of the embodiment of the present disclosure.

In an optional solution of the embodiment of the present disclosure, the drive mechanism further includes a transmission component 400; and an input end of the transmission component 400 is in transmission connection with the drive member 100, and an output end of the transmission component 400 is connected to one end of the active component 200 away from the support member 300.

Specifically, the axes of the active component 200, the support member 300 and the drive member 100 are collinear.

The input end of the transmission component 400 is in transmission connection with the drive member 100, and the output end of the transmission component 400 is connected to the active component 200, so as to achieve the manner that the drive member 100 drives the active component 200 to make the straight reciprocating movement along the axis direction of the support member 100.

In an optional solution of the embodiment of the present disclosure, the transmission component 400 includes a screw 410 and a nut seat 420; the screw 410 is fixedly connected to an output shaft of the drive member 100; and the nut seat 420 is sleeved with the screw 410 and connected to the active component 200.

Specifically, the drive member 100 is set as a motor, and an output shaft of the motor is fixedly connected to the screw 410 through a coupling; and an external thread is arranged on a peripheral surface of the screw 410, an internal thread is arranged in the nut seat 420, and the external thread is in threaded connection with the internal thread.

The output shaft of the drive member 100 rotates so as to drive the screw 410 to rotate; and the screw 410 is in threaded connection with the nut seat 420, so the screw 410 rotates and drives the nut seat 420 to make the straight reciprocating movement along the axis direction of the screw 410.

In an optional solution of the embodiment of the present disclosure, the nut seat 420 is detachably connected to the active component 200 through the clamping structure.

Specifically, please refer to FIG. 4, the section of the nut seat 420 is set to be circular, and the two ends of the nut seat 420 are subjected to chamfering treatment.

The nut seat 420 is detachably connected to the active component 200 through the clamping structure, so as to conveniently install and remove the active component 200.

In an optional solution of the embodiment of the present disclosure, the clamping structure includes installation blocks 421 or grooves 230 arranged on the nut seat 420, and the grooves 230 or the installation blocks 421 arranged in the active component 200 correspondingly; and the installation blocks 421 are inserted into the grooves 230, and fasteners are in threaded connection with the grooves 230 by penetrating through the installation blocks 421.

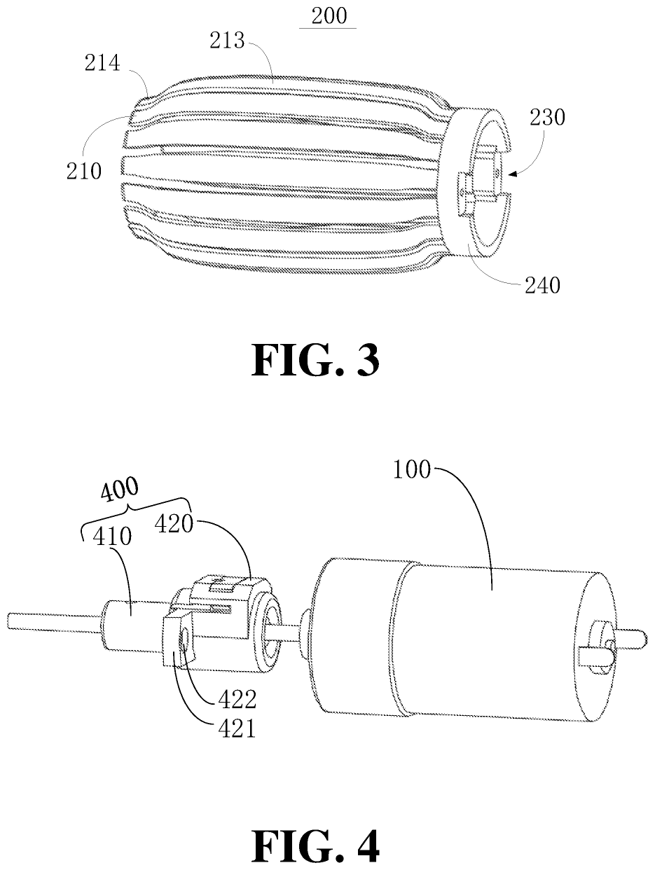

Specifically, the clamping structure includes the installation blocks 421 arranged on the nut seat 420 and the grooves 230 arranged on the active component 200, the installation blocks 421 are inserted into the grooves 230, and the fasteners are in threaded connection with the grooves 230 by penetrating through the installation blocks 421; or the clamping structure includes the grooves 230 arranged on the nut seat 420 and the installation blocks arranged on the active component 200, the installation blocks 421 are inserted into the grooves 230, and the fasteners are in threaded connection with the grooves 230 by penetrating through the installation blocks 421. In this embodiment, please refer to FIG. 3 and FIG. 4, the clamping structure includes installation blocks 421 installed on the nut seat 420 and grooves 230 arranged on the installation part 240 of the active component 200; and the installation blocks 421 are protruded from the peripheral surface of the nut seat 420 and provided with through holes 422, an axis direction of each through hole 422 is parallel to that of the nut seat 420, and a bolt is in threaded connection with the bottom wall of each groove 230 after penetrating through the through hole 422. Further, two installation blocks 421 and two grooves 230 are arranged, the two installation blocks 421 are arranged in relative to each other, and the two grooves 230 are arranged correspondingly to the two installation blocks 421.

The manner that the fasteners are in threaded connection with the grooves 230 by penetrating through the installation blocks 421 realizes the detachable connection between the nut seat 420 and the active component 200, and then the straight reciprocating movement of the active component 200 driven by the drive member 100 is achieved. Two installation blocks 421 and two grooves 230 are arranged, so as to strengthen the connection strength between the nut seat 420 and the active component 200. Certainly, the quantity of the installation blocks 421 and the grooves 230 may be four, etc., which should be within the protection scope of the embodiments of the present disclosure.

In an optional solution of the embodiment of the present disclosure, the drive mechanism includes a shell 500; one end of the shell 500 is inserted into the active component 200, and connected to the support member 300; and the drive member 100 and the transmission component 400 are arranged in the shell 500.

Specifically, one end of the shell 500 is provided with a bulge 520, the support member 300 is provided with a slot 320, and the bulge 520 is inserted into the slot 320, so as to achieve the connection between the shell 500 and the support member 300. The shell 500 includes an upper shell 500 and a lower shell 500, and the upper shell 500 is set in relative to the lower shell 500, so as to enclose a space for containing the drive member 100 and the transmission component 400. Further, the upper shell 500 is detachably connected to the lower shell 500, so as to conveniently install, disassemble and maintain parts in the shell 500.

One end of the shell 500 is connected to the support member 300 and inserted into the active component 200, so as to achieve a support function for the active component 200; and the drive member 100 and the transmission component 400 are arranged in the shell 500, so as to achieve a containing function of the shell 500 for the drive member 100 and the transmission component 400.

In an optional solution of the embodiment of the present disclosure, guide grooves 510 are arranged in the shell 500; the guide grooves 510 penetrate through the shell 500 along a thickness direction of the shell 500, and a length direction is arranged along the axis direction of the drive member 100; and the installation blocks 421 penetrate through the guide grooves 510, and the guide grooves 510 are configured to guide the movement direction of the nut seat 420.

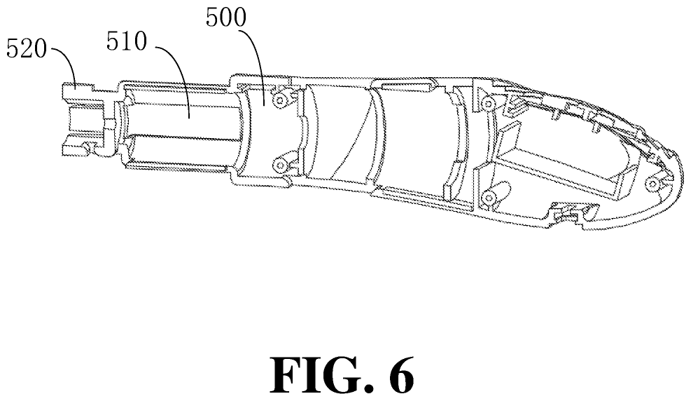

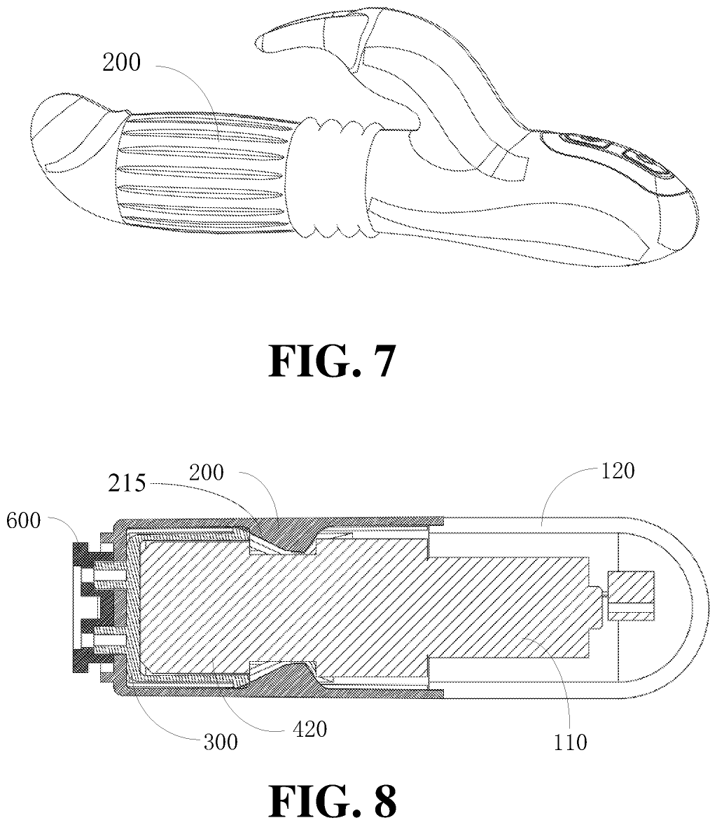

Specifically, please refer to FIG. 6 and FIG. 7, the upper shell 500 and the lower shell 500 are all provided with the guide grooves 510, and the two guide grooves 510 are arranged correspondingly to the two installation blocks 421.

The installation blocks 421 penetrate through the guide grooves 510, and the guide grooves 510 limit the installation blocks 421 only to make straight movement along the axis direction of the drive member 100. The drive member 100 drives the screw 410 to rotate, when the screw 410 drives the nut seat 420 to move, the guide grooves 510 limit the installation blocks 421 arranged on the nut seat 420 only to move along the axis direction of the drive member 100, thereby limiting a threaded seat only to move along the axis direction of the drive member 100, and the nut seat 420 drives the active component 200 to make the straight movement along the axis direction of the drive member 100.

### Embodiment II

In an optional solution of the embodiment of the present disclosure, when the nut seat 420 is connected to the support member 300, and the drive mechanism further includes a fixed member 600; one end of the support member 300 is sleeved with the nut seat 420 while the other end of the support member 300 is connected to the fixed member 600 by penetrating through an end face away from the installation part 240 of the active component 200, so as to achieve the transmission connection between the active component 200 and the drive member 100.

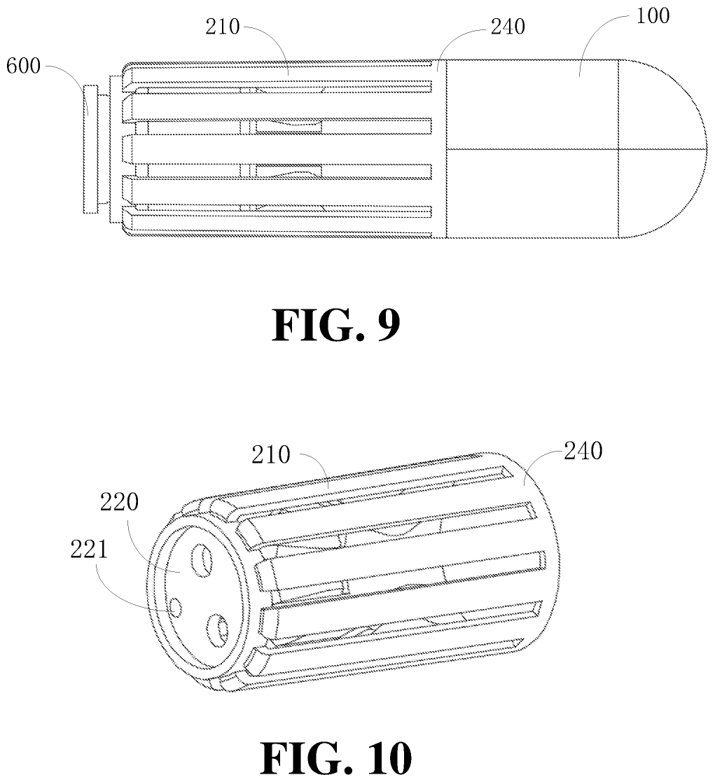

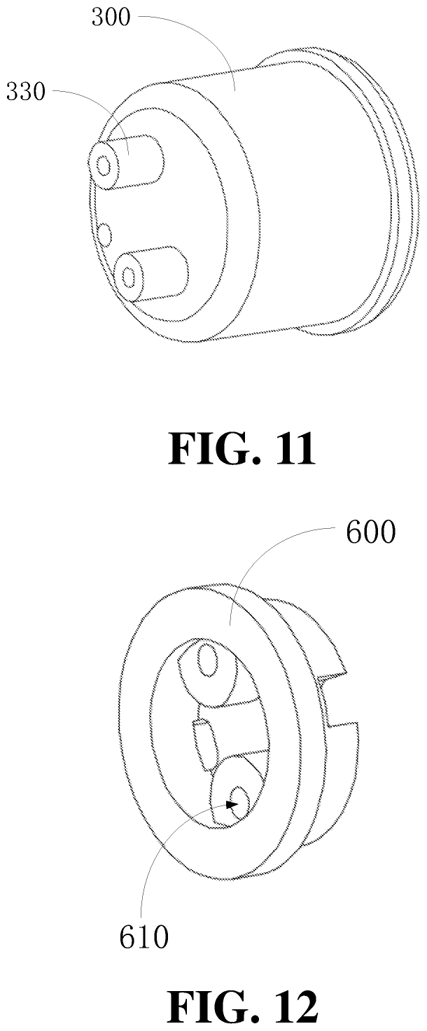

Specifically, please refer to FIG. 8 to FIG. 12, one end of the support member 300 is provided with an opening, and the nut seat 420 is clamped in the opening; the other end of the support member 300 is provided with a locating bulge 330; the fixed member 600 and the locating bulge 330 are provided with clamping holes 610 correspondingly; one end of the active component 200 is provided with an installation part 240, so as to integrate a plurality of frameworks 210, the other end of the active component 200 is provided with a connecting end face 220, and an installation hole 221 is formed in the connecting end face; and the locating bulge 330 extends out of the installation hole 221, so as to be clamped with the clamping hole 610.

When the drive mechanism runs, the support member 300 makes the straight reciprocating movement with the nut seat 420 along the axial direction of the active component 200; the support member 300 is connected to the connecting end face 220 of the active component 200 through the fixed member 600, so the active component 200 is driven to make the straight reciprocating movement under the drive of the support member 300. The inner diameter of the containing space 220 is gradually reduced from one end away from the installation part 240 to one end closing to the installation part 240, so the increased or reduced outer diameter of the active component 200 is achieved when the active component 200 makes the straight reciprocating movement. Taking FIG. 8 as an example, FIG. 8 is an extending state of the drive member 100; when the drive member 100 drives the support member 300 to move left, the first inclined plane 215 of the auxiliary framework 212 keeps fitting with the outer wall of the support member 300, and the first inclined plane 215 inclines along the axis direction of the installation part 240 from one end away from the installation part 240 to one end closing to the installation part 240; the distance between the outer wall of the framework 210 and the outer wall of the support member 300 is getting smaller and smaller from right to left, so as to achieve smaller and smaller outer diameter of the active component 200; when the drive member 100 drives the support member 300 to move right, the first inclined plane 215 of the auxiliary framework 212 keeps fitting with the outer wall of the support member 300, and the first inclined plane 215 inclines along the axis direction of the installation part 240 from one end away from the installation part 240 to one end closing to the installation part 240; and the distance between the outer wall of the framework 210 and the outer wall of the support member 300 is getting greater and greater from left to right, so as to achieve the greater and greater outer diameter of the active component 200.

In an optional solution of the embodiment of the present disclosure, the drive member 100 includes a main engine 110 and an outer shell 120; and the main engine 110 partially stretches into the outer shell 120, the other part of the main engine 110 stretches into the active component 200, and an opening end of the outer shell 120 is connected to the installation part 240 of the active component 200.

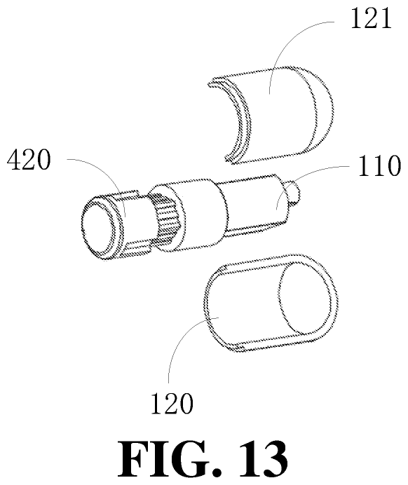

Specifically, please refer to FIG. 13, the outer shell 120 includes an upper cover 121 and a lower cover 122, and the upper cover 121 is detachably connected to the lower cover 122.

The detachable connection between the upper cover 121 and the lower cover 122 is convenient to install and disassemble the main engine 110.

Finally, it should be noted that the above embodiments are merely used for illustrating the technical solution of the present disclosure instead of limiting it. Although the present disclosure is described in details with reference to the above embodiments. Those of ordinary skill in the art should understand that they can still make modifications to the technical solution recorded in the above embodiments, or make equivalent replacements to part or all of technical characteristics. However, these modifications or replacement do not separate the nature of the corresponding technical solution from the scope of the technical solution of various embodiments of the present disclosure.

What is claimed is:

1. A drive mechanism, comprising a drive member (100), an active component and (200) a support member (300); wherein
the active component (200) is sleeved on the support member (300), and an inner wall of the active component (200) resists to an outer wall of the support member (300);
the drive member (100) is in transmission connection with the active component (200), so as to drive the active component (200) to make a straight reciprocating movement along an axis direction of the support member (300); and
an outer diameter of the active component (200) is increased or reduced along the movement of the active component (200).

2. The drive mechanism according to claim 1, wherein the active component (200) comprises an installation part (240) and a plurality of frameworks (210);
the installation part (240) is connected to the drive member (100);
one end of each framework (210) is connected to the installation part (240), and an inner wall of each framework (210) resists to the support member (300); and
the plurality of frameworks (210) are arranged along a circumferential direction of the installation part (240) at intervals, so as to form a containing space (220) for containing the support member (300), and an inner diameter of the containing space (220) is gradually reduced from one end away from the installation part (240) to one end closing to the installation part (240).

3. The drive mechanism according to claim 2, wherein each framework (210) comprises a main framework (211) and an auxiliary framework (212);
one side of the auxiliary framework (212) fits with an inner wall of the main framework (211), and the other side of the auxiliary framework (212) is set as a first inclined plane (215); and
the first inclined plane (215) inclines in an axis direction closing to the installation part (240) from one end away from the installation part (240) to one end closing to the installation part (240).

4. The drive mechanism according to claim 3, wherein the drive mechanism further comprises a transmission component (400);
the transmission component (400) comprises a screw (410) and a nut seat (420);
the screw (410) is fixedly connected to an output shaft of the drive member (100); and
the nut seat (420) is sleeved on the screw (410), and connected to the active component (200) or the support member (300).

5. The drive mechanism according to claim 4, wherein when the nut seat (420) is connected to the active component (200), the nut seat (420) is detachably connected to the installation part (240) through a clamping structure;
the clamping structure comprises installation blocks (421) or grooves (230) that are arranged on the nut seat (420), and the grooves (230) or the installation blocks (421) that are correspondingly arranged on the installation part (240); and
the installation blocks (421) are inserted into the grooves (230), and fasteners are in threaded connection with the grooves (230) by penetrating through the installation blocks (421).

6. The drive mechanism according to claim 5, wherein the drive mechanism comprises a shell (500);
one end of the shell (500) is inserted into the active component (200), and connected to the support member (300); and
the drive member (100) and the transmission component (400) are arranged in the shell (500).

7. The drive mechanism according to claim 6, wherein the shell (500) is provided with guide grooves (510);
the guide grooves (510) penetrate through the shell (500) along a thickness direction of the shell (500), and the length directions of the guide grooves (510) are arranged along an axis direction of the drive member (100); and
the installation blocks (421) penetrate through the guide grooves (510), and the guide grooves (510) are configured to guide a movement direction of the nut seat (420).

8. The drive mechanism according to claim 7, wherein the support member (300) is provided with a plurality of installation grooves (310); and
the plurality of installation grooves (310) are in sliding fit with the plurality of auxiliary frameworks (212) correspondingly.

9. The drive mechanism according to claim 4, wherein when the nut seat (420) is connected to the support member (300), the drive mechanism further comprises a fixed member (600); and one end of the support member (300) is sleeved with the nut seat (420) while the other end of the support member (300) is connected to the fixed member (600) by penetrating through an end face away from the installation part (240) of the active component (200), so as to achieve the transmission connection between the active component (200) and the drive member (100).
